(19) United States
(12) Patent Application Publication
(10) Pub. No.: US 2014/0156363 A1
(43) Pub. Date: Jun. 5, 2014

(54) MODIFYING FUNCTIONALITY AND ADVERTISEMENT CONTENT ON MEDIA PLAYERS

(71) Applicant: CBS INTERACTIVE INC., San Francisco, CA (US)

(72) Inventor: James Kong Hsu, Redwood City, CA (US)

(73) Assignee: CBS Interactive Inc., San Francisco, CA (US)

(21) Appl. No.: 13/706,292

(22) Filed: Dec. 5, 2012

(51) Int. Cl. G06Q 30/02

(52) U.S. Cl. CPC G06Q 30/0241
USPC 705/14.4

(57) ABSTRACT

Disclosed herein are systems, methods, and non-transitory computer-readable storage media for modifying media player functionality and controlling advertisements included with media content played on media players. Chromeless media players may be created by content providers but modified by third party clients that wish to adapt the players to their purposes. These chromeless players may have defined modified functionality, such as removing the ability to fast forward, rewind, and skip chapters, according to a given circumstance. In an embodiment, the third party client may also define in a profile the specific advertisement sets to include with media content played on its chromeless player. In other embodiments, other types of additional media may be defined by the third party client. A proxy server, or intermediary server, detects these factors prior to retrieving media content. The proxy server then determines, based on established rules and profiles, what content or functions the media player has access to and communicates compliant media content to the media player. An administrator can create, modify, or remove these rules and profiles through a portal or other interface with the proxy server.

### BACKGROUND

1. Technical Field

The present disclosure relates to modifying functionality and advertisement on media players and more specifically to restricting media accessibility, media player functionality, and advertisement selection based on attributes of the media player, the media content, and preferences of the content provider.

2. Introduction

Providing online media content can involve a complex array of back-end computing devices, networks, and software platforms. As used herein, media includes primary content (e.g., a movie, television show, documentary, drama, music video and the like) and secondary/additional content (e.g., advertisements, inserts, notices, messages and the like). Among the many considerations, such as media storage location and network ports, providers typically select secondary content to include in addition to the primary content. For example, a provider showing a movie can provide the movie alone, or can provide the movie, advertisements, closed captioning, surround sound audio encoding, and other media features. The provider must also determine what functions the viewer of the media content can utilize, especially in video streaming to a computer or mobile device. Functions such as pausing, playing, controlling the volume, turning on/off closed captioning, adjusting brightness, rewinding, fast forwarding, recording, bypassing commercials, or providing embeddable code for sharing are all options the provider can build into the media player.

Media players can control these functions and adjust media content. When the online media content provider is the only entity providing a specific media player, that media content provider can customize the media player to have specific content and functionality in accordance with the media content provider's wishes. For example, if desirable, the content provider can allow viewers to skip commercials, fast forward, etc. However, often the content provider designs a media player and then allows its use by third parties. In such situations, the third party will often change the appearance of the media player such that it appears to belong exclusively to and been designed by the third party, rather than to the content provider. This changed appearance, also known as a skin, simply changes the appearance of the media player, not the functionality associated with the media player. There may, however, be situations where the content provider wishes to limit the functionality and content manipulation available to third party users of the media player. Third parties are thus able to relay media content from providers to viewers with additional media enhancements or restrictions, such as in available functionality.

Advertisement is often included with media provided by content providers as a way of generating revenue. Advertisements typically include commercial clips inserted into provided media, pop-up windows, embedded commercials in a media player skin and so forth. Media contents supplied by content providers often have advertisement slots (e.g., commercial breaks) inserted at certain time intervals. Advertisements are often added into these slots by content providers, with the combination of media content and advertisements being supplied to third parties to show to users through media players. However, a third party may desire more control over the advertisement content and wish to customize the set of advertisements included with the media content rather than use the generic set already inserted by content providers. Specialized advertisements may both enhance the viewing experience for users and allow third parties to create targeted advertisement sets. For example, a third party shows media content to a specific group of users. Specialized or targeted advertisements in the media content may appeal more to users and thus create a better viewing experience.

Current solutions involve writing custom chromeless clients with different sets of rules or different subsets of functionality tailored for a particular use case or client. Chromeless clients are basic media players that can be modified for specialized purposes, such as matching a website, embedding advertisements, or restricting functionality. This approach is not cost effective, and can prove prohibitively expensive or complex for some potential media distribution outlets, even with assistance from the content provider. Furthermore, content providers currently combine the same generic advertisements with media content supplied to all third parties. Third parties are unable to change the provided advertisements without a lengthy process of splicing and altering the provided media content, which may be prohibitively expensive for some third party distributors.

### BRIEF DESCRIPTION OF THE DRAWINGS

In order to describe the manner in which the above-recited and other advantages and features can be obtained, a more particular description of the principles briefly described above will be rendered by reference to specific embodiments thereof which are illustrated in the appended drawings. Understanding that these drawings depict only exemplary embodiments and are not therefore to be considered to be limiting of its scope, the principles herein are described and explained with additional specificity and detail through the use of the accompanying drawings in which:

FIG. 1 illustrates an example system embodiment;

FIG. 2 illustrates an example network configuration embodiment;

FIG. 3 illustrates an example of a functionally restricted media player;

FIG. 4 illustrates an example of a increased functionality media player;

FIG. 5 illustrates an example advertisement pairing; and

FIG. 6 illustrates an example method embodiment.

### DETAILED DESCRIPTION

Various embodiments are discussed in detail below. While specific implementations are discussed, it should be understood that this is done for illustration purposes only. A person skilled in the relevant art will recognize that other components and configurations may be used without parting from the spirit and scope.

### Overview

Disclosed are systems, methods, and non-transitory computer-readable storage media for determining media player functionality and controlling advertisements included with media content played on media players. As mentioned previously, media content contains primary content (e.g., movies, television shows, documents and the like) and secondary content (e.g., advertisements, inserts, notices, pop-up windows). Media content is provided by a main content provider and passes through a third party client before being played back by a media player to a user. Third party clients may include entities that relay media content from media providers to viewers, modify media content to include specialized additional content, customize media players for specific purposes and the like. To control the playback of media, the third party client may modify its media player for reduced functionality as well as specify to content providers which advertisements to insert into media content. For example, modified functionality may include removing the ability to fast forward, rewind, pause, and skip chapters in media content provided through the third party client. Factors, such as the identity of the user of the media player, the identity of a third party client, a time of use, and the content being played can define what functionality is included in the media player in a given circumstance.

In addition, the third party may control media content that is played its media player by actively selecting certain advertisements and other metadata (e.g., media player enhancements, pop-up windows, overlays, notices, subtitles, and so forth) to show with the main media content. As used hereon, advertisements and other metadata will both be referred to upon mentioning advertisements. Media content provided by a main content provider through a third party client may have certain time intervals reserved for advertisements. Third party clients may select certain sets of advertisements to fill these time intervals, rather than allowing the main content provider to insert the same generic advertisements for all third party clients. Thus, the same media content provided by the same content provider may contain different sets of advertisements when viewed through different third party clients. The advertisement sets may be created with regards to factors such as the audience demographics, specific interests, viewing locations, and so forth, and may be associated with a specific third party client profile. Third party client profiles are information and statistics regarding each third party client and may be used to identify both a third party and the type of media player customized by a third party client.

A proxy server, or intermediary server, can analyze customized media players and retrieve third party client profiles to determine rules and identifiers associated with the media player. The proxy server then determines, based on the determined information, what type of media player is making a request for media. The “type” of media player relates to the content or functions the media player has access to in part due to the third party client. Upon identifying a media player type, proxy server communicates compliant media content to the media player. An administrator can create, modify, or remove rules and identifiers through a portal or other interface with the proxy server. Thus, although two media players might request the same primary media content, each player may receive an overall different media content based on a player's type. Since media comprises of both primary media and secondary media, both media players may be sent the same primary media content but differing secondary media content.

In an embodiment, a chromeless player is a minimal media player that provides little or no user interface elements or “chrome”. For example, a chromeless player can be an app on a mobile device, a software package on a desktop or laptop computer, a Java applet, an embedded player on a web page, and so forth. A chromeless player generally does not include borders, widgets, a frame, or other user interface elements for playing the video. However, in a web page, for example, other user interface elements can be arranged around, proximate to, overlaid on, or otherwise situated for the chromeless player for controlling or manipulating the playback of the video in the chromeless player.

A chromeless player may remain chromeless and simply play back media without any user controls. A third party client can further customize the chromeless player with appropriately styled user interface elements, branding, controls, and other appearance enhancements to match a particular operating system, style, layout, or other requirements, all without the need to write a custom chromeless player. In the process, the third party client may also attach an identifier onto the chromeless player so that a proxy server may recognize the media player as belonging to a specific third party client. The identifier thus establishes the “type” of the media player. The proxy server can automatically restrict the functionality of the chromeless player for the specific task based on these attributes or flags. These attributes or flags may also be designed to be dynamic, thereby the altering the set of allowed functionality over time. For example, a chromeless player allow media navigation controls during playback of primary content, and disallow those controls during playback of an advertisement between segments of the primary content. In addition, the identifier tags on a chromeless player may also indicate to the proxy server that a specific third party client had customized the chromeless player. In response, the proxy server may merge a targeted advertisement set associated with that third party client into media content sent to the player.

An example system first receives, from a media player, a request for media playback. The system then identifies what type of media player is making this request and through which third party client the media player is being played from. This identification can occur based on factors such as various aspects of the media player (e.g., associated user account, third party client, associated “chrome”), the situation surrounding the request (e.g., time of day, connectivity capabilities, network address), or the requested media. The system then determines, based at least in part on the type of media player and a rule, an allowed subset of functions this media can use during playback of the requested media. In addition, the system may retrieve the third party client's profile from stored databases. This profile may specify a specific set of advertisements to insert into advertisement segments in the primary media content requested. The system merges this set of advertisements into the primary media content before sending it to a media player for playback.

### Example Computing System Architecture

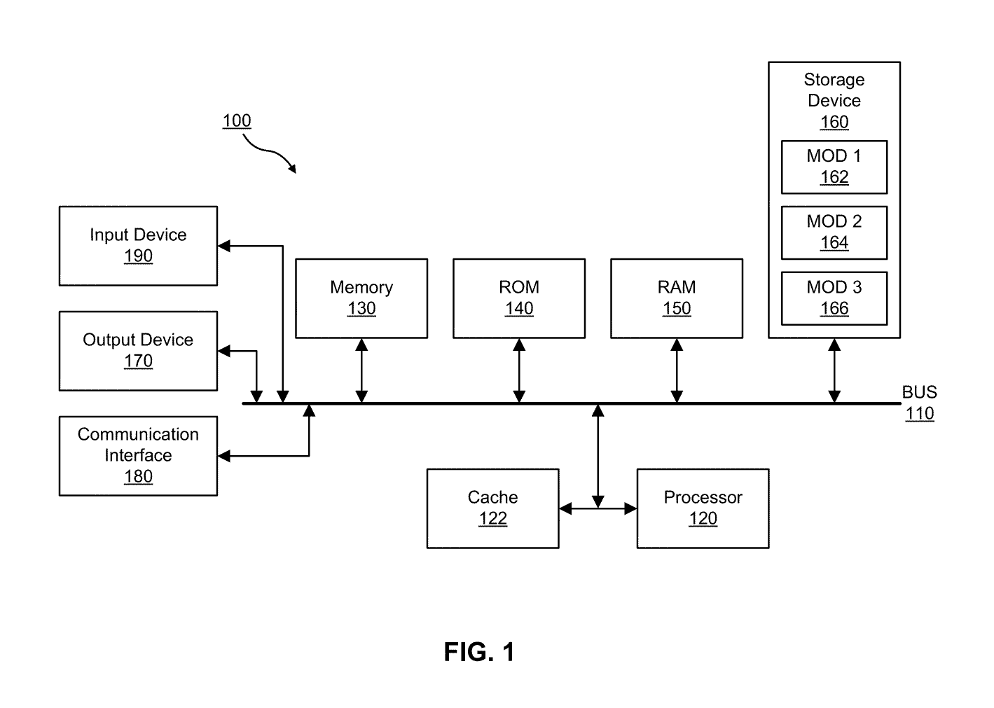

A system, method and non-transitory computer-readable media are disclosed which identify the type of media player making a content request, the functionality associated with that type of media player, and return content in accordance with the allowed functionality. To better understand the disclosed configuration, a brief introductory description of a basic computing system (or computing device) is provided in conjunction with FIG. 1. This computing device can be employed to practice the concepts is disclosed herein. A more detailed description of modifying media player functionality will then follow, with various embodiments and configurations described. These variations shall be discussed herein as the various embodiments are set forth.

With reference to FIG. 1, an exemplary system 100 includes a general-purpose computing device 100, including one or more processing units (e.g., CPU or processor) (referenced as processor 120) and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions.

Other system memory 130 may be available for use as well. The memory 130 can include multiple different types of memory with different performance characteristics. It can be appreciated that a computing device 100 can have more than one processor 120 or can be a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120.

Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a tablet computer, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

### Example Network Configuration

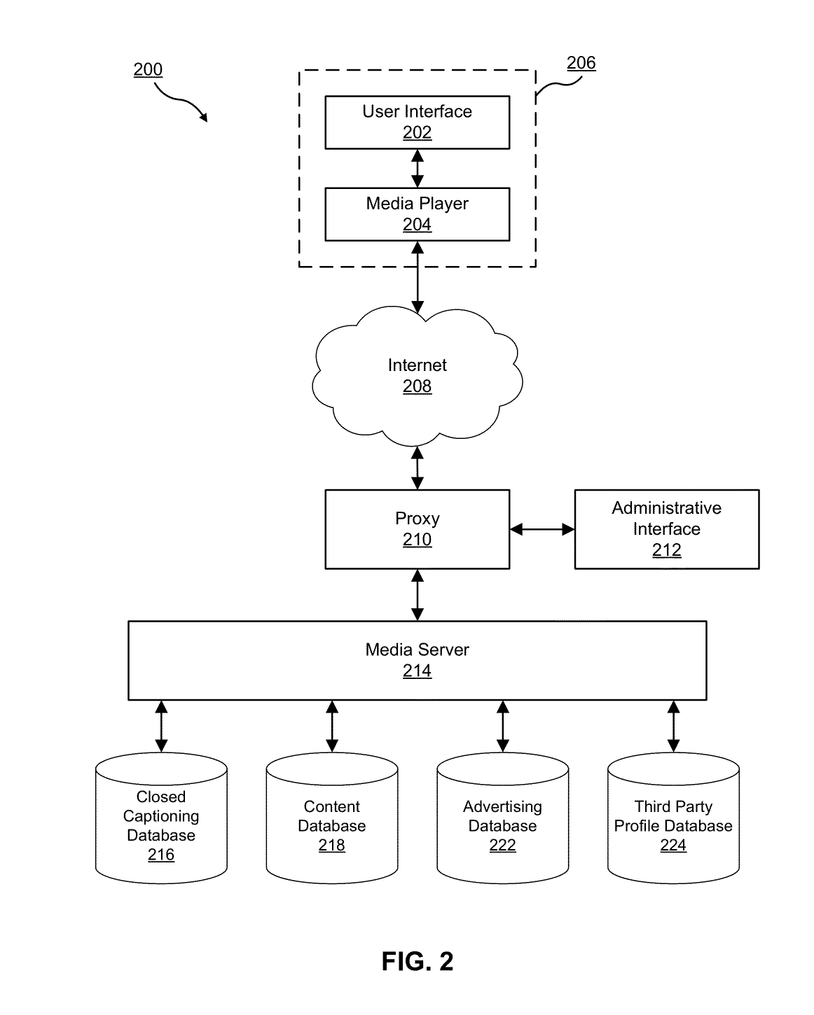

Having disclosed some components of a computing system, the disclosure now turns to FIG. 2, which illustrates an exemplary network configuration 200. In this configuration 200, a user interacts with a user interface 202. This user interface 202 works directly with the media player 204. The user interface 202 can be a Graphical User Interface (GUI), a spoken interface, a touch interface, and so forth, and the appearance of this user interface 202 can vary. These variations of the user interface, also known as skins or chrome, can change the appearance of a media player 204. Media players 204 without a skin, or chromeless players, provide a platform for playing media content with the intention that each third party distributor of the media player 204 creates a proprietary skin. This allows the third party to give the appearance that the media player is their own, for example. A content provider can provide a chromeless solution for media content distribution to multiple different clients, and the third party can customize the look and feel of the chromeless player for each client. However, each third party may have a profile associated with it that maintains specifications (e.g., content restrictions, advertisement sets, player functionalities) for media sent to chromeless players customized by the third party.

The media player 204 and the user interface 202, normally found together 206 at the final user's terminal, remain separate from the proxy server 210 and the media server 214 by the Internet 208 or some other communication network. In other configurations, the media player/user interface combination 206 remains separated by a network connection, a fiber optic link, or other communication link from the proxy server 210 and the media server 214. The proxy server 210 receives requests for media content from the media player 204 and identifies the media player 204. The proxy server 210 may also retrieves information from a third party profile database 224 via media server 214 for additional instructions on how to interact with the media player 204. Often, the media player 204 communicates its identity with the request for media content. Based on the identity of the media player 204 and a retrieved profile, the proxy 210 determines what functionality and content are available for playback through the media player 204.

In other cases, the proxy 210 must determine the identity using non-determinative data, such as the type of skin on the media player, the time of day, the connectivity capabilities, the type of media being requested. In these non-determinative cases, the proxy 210 may not know the exact identity of the media player 204, but does have enough information that it can determine at least one rule associated with media content playback. For instance, the proxy 210 can detect that the skin of the media player 204 belongs to a third-party distributor who only has the right to play and pause video content. In such a circumstance, if the media player is requesting to skip to the next chapter in the video, the proxy 210 determines that it is not a valid request and obtains only allowable content from the media server 214. In other configurations, the proxy 210 can return a message to the media player 204 that the request is not allowed on the media player 204 being used. Furthermore, identifying a third-party distributor allows media server 214 to access the correct advertisement set based on the third party distributor's profile. The advertising content can then be added to media content sent to media player 204.

An administrator can modify the rules and identifiers for media players which are verified on the proxy 210. These modifications can take place through an administrative interface 212 which corresponds to the proxy server 210. These rules and identifiers can be used to both define the functionality allowed on a media player 204 and identify the third party profile associated with each media player 204. For example, certain media players 204 may be able to fast forward or skip through movie scenes while other media players 204 are restricted to only a play and pause function. In addition, certain media players 204 will have access to certain sets of advertisements in accordance with the associated third party profile, while other media players 204 may not have access to the same sets due to being customized by other third-party distributors.

Different media player rules may give the same effect on functionality. For instance, if a media player 204 has closed captioning functionality, but not given access to closed captioning content, the effect is the same—the user receives no closed captioning. Other exemplary rules the administrators can define can be based on the time of the request, the original date of the content being requested, the number of times the content has been requested, either by that media player or by all media players, and requests made by an Application Programming Interface (API). Still other rules may depend on the nature of the content being retrieved (live versus previously recorded), the connectivity to the user (802.11 wireless, 3G or other cellular wireless connections, wire, fiber-optic), or resolution requested (1080i versus 480p).

Certain rules can change depending on the time or circumstances of the request. For instance, a rule may state that users cannot skip advertisements for the first thirty days a video is posted online, but after that they can skip exactly one advertisement. Another rule may state that limited functionality is available after 6 P.M. for a particular region, but prior to 6 P.M. users have full functionality. Yet another rule may place functional limitations on live events, such as the inability to fast forward, but modify the rule upon subsequent replays of the event. Certain rules can have restrictions, such as only opening full functionality if the user watches a certain commercial, correctly enters a codeword, or pays a fee.

Content restrictions can likewise be limited by time, media player identifiers, and other factors. For example, a rule may direct advertising content to one database during daytime hours and a second database during evening/night hours. Likewise, a particular advertiser may wish to pay a premium for their advertisements to be associated with a piece of media content for the first six months of availability, after which the advertiser wishes only to have a sponsorship message followed by no commercials. A third party distributor may also wish to select certain advertisements for broadcast to users using their media players, different from the generic set provided by content providers or other third party distributors. Identifiers on media players may direct proxy server to retrieve specific third party profiles, which indicate that media sent by media server 214 to these media players should contain a specific set of advertisements.

Based in part on the rules associated with the media player 204 and content specifications from a third party profile, the proxy 210 forwards a modified media request to the media server 214. This modified media request is the original content request received from the media player 204, modified by the proxy 210 in accordance with the rules and content specifications. The media server 214 in turn requests allowed media content from databases in accordance with the allowed functionality and requested content. As illustrated, the media server 214 requests data from a closed captioning database 216, a content database 218, and an advertising database 222 for transmitting to a media player 204. Other exemplary databases the media server 214 could request data from are watermarking, surround sound, foreign language, edited, unedited, split screen, director commentary, and musical score databases. Once retrieved, the content from these databases 216, 218, 222 is forwarded from the media server 214 through the proxy 210, back through the Internet 208 to the media player 204 which made the request, and finally presented to the user through the user interface 202. Depending on the method of data transfer, this process may occur once or repeated often. Third party profile database 224 is primarily used to determine content specifications (e.g., advertisement sets) for media content sent to media players 204 associated with each third party client. Communication between the media server 214 and third party profile database 224 may occur independent of communication between media server 214 and the other databases 216, 218, 222.

In some example embodiments, a chromeless media player as disclosed herein includes further incorporating a closed caption feed engine (not shown) with a closed caption metadata analysis engine (not shown). By way of example, the content in the content database 218 includes closed captioning from the closed caption database. As the media player 204 plays the content, the closed caption feed engine analyzes the closed captioning feed and uses the closed caption metadata analysis engine to do a real-time analysis of the feed. Based on this analysis, the analysis engine has the media player 204 retrieve or pull in an advertisement from the advertising database 222 corresponding to the analyzed feed, in accordance to a list of pre-selected advertisements for each third party client. The advertisement sent to the media player 204 can be in the form of a user interface skin that changes the user interface 202 real-time (or “on the fly”) or as a conventional advertisement shown during commercial breaks.

In an embodiment of a user interface skin advertisement, if the closed caption metadata analysis engine analyzes a closed caption feed a dialog corresponding to use of a smartphone, the analysis engine has the media player 204 request an advertisement from the advertisement database 222 corresponding to a smartphone. The advertisement database 222 can check its records to see what type of advertisement to return and can decide to return an advertisement for a MOTOROLA DROID. The returned advertisement is in the form of a user interface frame with the MOTOROLA DROID advertisement filling the frame and within which the media player 204 will place the content. The advertisement frame with content is played within the user interface 202. The user interface frame also will include additional or changed media control elements that allow the content playback to be manipulated (e.g., paused and later fast forwarded) based on the interaction with the advertisement.

In an embodiment of a conventional advertisement, the advertisements retrieved from advertising database 222 may be individual advertisements corresponding to a set of advertisements selected by a third party distributor for a particular media player. Main content retrieved from content database 218 may have empty segments reserved for advertisements. For example, a 30 minute television show may be broken into 3 sub-segments with 2 commercial breaks in-between sub-segments. The selected advertisements from advertising database 222 may be inserted into these commercial break intervals according to the third party distributor. Thus, media received from different third party distributors may have different advertisement content included.

Note that the real-time customization of the media player and selection of specialized advertising for media players are beneficial for live events. In an example embodiment, for live sports programming such as a baseball game, the media player can be customized in real-time to correspond with an analysis of who is batting or pitching and immediately providing an advertisement that enables purchasing a jersey of the particular batter or pitcher being shown directly through interaction with the particular user interface 202 shown with the content through the media player 204 at that time. Each third party distributor may prepare a list of selected advertisements ahead of time and store the list in a third party profile database 224. Media server 214 may be restricted to using advertisements on this list when sending media content to media players 204 that are associated with the third party distributor. In an embodiment, during playback of the advertisements, the media controls can be changed (e.g., augmented) to include controls for allowing pause of the media content (e.g., in a DVR type manner) when a user is engaged in conducting a transaction based on the advertisement. When the transaction is completed the user is presented fast forward controls to allow for fast forwarding up to the current play time (e.g., back to live). When the current play time is reached, the changed controls are set back to the original controls provided through the media player until the next transaction is engaged through an advertisement interaction. This real time customization and enhanced advertisement targeting enable additional media controls to be passed to the user, provide a improved viewing experience for users, and allow third party distributors more control over content distributed through their customized media players.

In other example configurations, the media player 204 can be customized real time based on social media information. For example, the chromeless media player can include, or interface with, a social media stream analysis engine that identifies social media trends. Based on the trends identified, the media player 204 can accordingly configure controls available for interacting with content in the user interface 202. For example, in a live sporting event, if a social media stream identifies “chatter” about a highlight earlier in the game, the analysis engine can notify the server to provide user interface controls to allow for rewind of the content to the identified point within it corresponding to the “chatter.” During the course of a live event multiple such points in the content can be identified. The rewind controls will allow rewind to each of these points but not to other locations in the media content. Similarly, fast forward from each of these points leads to the next point for a highlight, but perhaps not content in between. In this example, the content owner continues to retain control over how the user interacts using the social media stream as the content control mechanism.

### Example Restricted Media Players

FIG. 3 illustrates an example of a functionally restricted media player 300. In this example, presentation of media content occurs through a user interface 302, but only limited functionality is available to a user controlling the viewing of the media content. In this example, the only functionality available is the play/pause function 306. In the user interface 302, while a media bar 308 displays the overall length of the media content, and a marker 304 on that bar 308 shows the current location, the user is prohibited from moving that marker 304 to other locations. With this limited functionality the user cannot skip ahead to another part, rewind, etc. The content in this example is limited such that the user cannot see when commercial breaks are occurring, or any other divisions. Other functionality which may be limited can include the ability to mute, adjust brightness, adjust surround sound, and adjust user preferences such as resolution, brightness, and contrast.

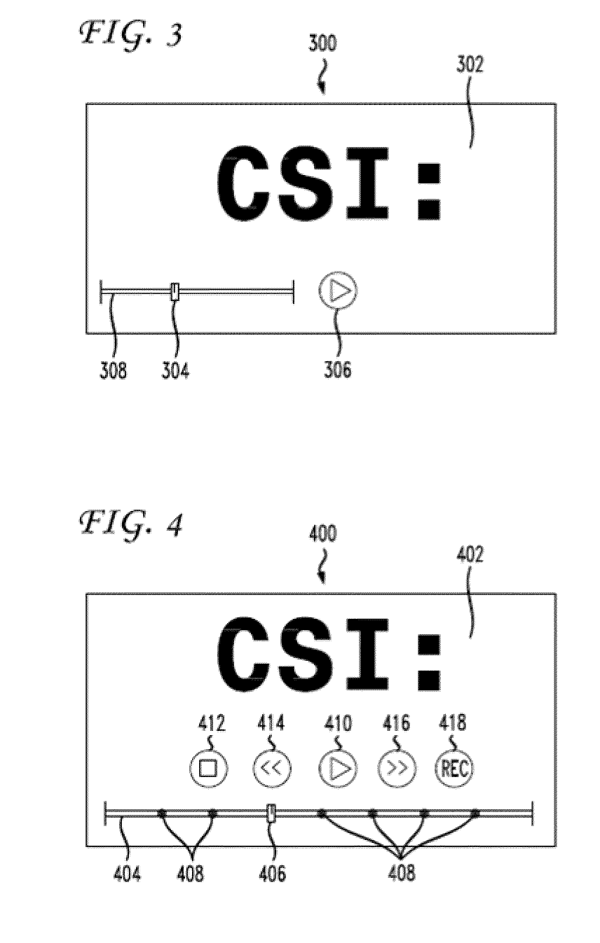

FIG. 4 illustrates an exemplary media player having increased functionality 400. As in FIG. 3, the media content is presented through a user interface 400, and another embodiment of a media bar 404 indicates the overall length of the media content with a marker 406 indicating the current location within the media content. However, unlike FIG. 3, the rules associated with this media player 400 allow for increased functionality. Specifically, the rules allow not only for play/pause functionality 410, but also for the ability to stop/reset 412, rewind 414, fast forward 416, and record the media. In addition, the user can now see when commercial breaks 408 will appear in the video because they are listed in the bar 404. While those features are illustrated, other features can be made available or limited depending on the rules defined by the administrator.

### Example Advertisement Pairing

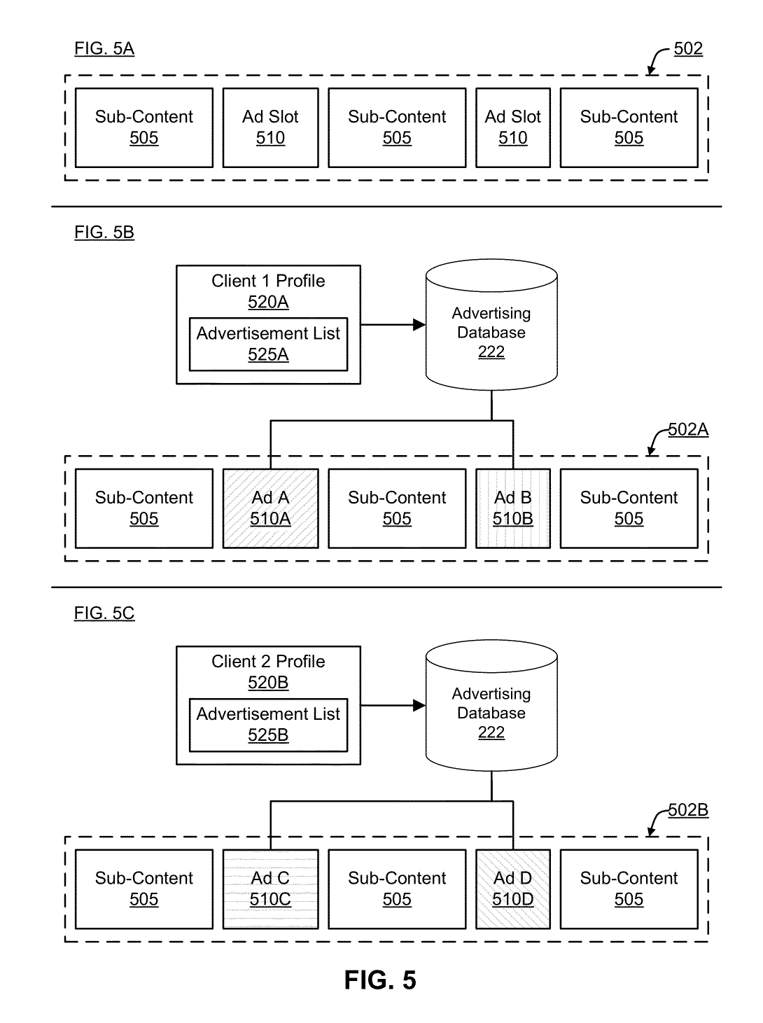

FIG. 5 illustrates how advertisements are paired with specific third party clients and included in media content sent through media players customized by the third party clients. A representative media feed 502 shown in FIG. 5A contains features that may include, but are not limited to, sub-contents 505 and ad slots 510. Main media content (e.g., movies, television shows, sports games, documentaries, live video feed) may be separated into sub-content 505 through splicing or truncation of whole contents. To maximize revenue from media content, content providers often add advertisement slots 510 during gaps between sub-contents 505. Conventionally, these advertisement slots 510 are filled with generic advertisements selected by the content provider and contain the same advertisements for all third party clients.

However, some third party clients may wish for more control over the media content distributed through their customized media players 204. This may include control over content such as the main media content and advertisement content. A third party client may select desired content for distribution and create a profile that details both the content specifications and the parameters within which content can be played back. This profile may be stored and referenced by a content provider when the provider sends media to media players 204 specific to the third party client. The profile may also be referenced to determine parameters for advertisements to serve within a content stream. Thus, instead of using generic advertisements selected by a content provider, third party clients may specific exactly which advertisements to use for media sent to their media players 204. Thus, media players from varying third party clients may request the same primary media content but receive differing secondary media content, which may cause a different viewing experience for viewers of each media player.

FIG. 5B illustrates an exemplary embodiment of advertisement pairing in relation to third party clients. When a media player 204 belonging to third party client 1 makes a request for media content from a content provider, an intermediate service may identify the third party client that had distributed the media player 204. Using this identification, the intermediate service can retrieve a profile 520A associated with the third party client. This profile may contain specifications for which contents are available to the third party client's media players (e.g., advertisement list 525A) and also what functionalities can be accessed. Media content may then be sent to the media player 204 in accordance to the specifications listed on the profile 520A.

For example, third party client 1 profile 520A contains a specific list of advertisements 525A that contains the set of advertisements that third party client 1 had wanted to be included with media content played through its media player 204. A media server 214 may access advertising database 222 and retrieve only advertisements (e.g., “ad A” 510A and “ad B” 510B) present on the advertisement list 525A. These advertisements are spliced together with existing sub-contents 505 to form media content feed 502A.

FIG. 5C shows an alternative embodiment where third party client 2 is making a request for content. Third party client 2 may want a different set of content to be distributed with media played through its media player 204. By accessing third party client 2 profile 520B, a media server 214 can determine which contents are available to third party client 2. For the same sub-content 505 as that requested by third party client 1, third party client 2 may request a different set of advertisements. This different set of advertisements is listed in a advertisement list 525B. Taking into account the differences, media server 214 retrieves a new set of advertisements (“ad C” 510C and “ad D” 510D) from advertisement database 222 and merges it with the same sub-content 505, thus creating media feed 502B.

Although a content provider received requests from two different third party clients' media players 204 for the same main content (sub-content 505), each third party client was able to maintain some control of the additional content that was inserted into the media feeds. Third party clients 1 and 2 were both able define their own unique set of advertisements from a common database of advertisements 222. Media server 214 can then merge together the main media content with a personalized advertisement set to provide unique media feeds 502A, 502B. The viewing experience for each user is thus different depending on the third party profile.

Third party clients may select advertisements for their media feeds using various criterions. These criterions may include, but is not limited to, location of advertisement (relative to content or environment of playback), frequency, source of advertisement, type of advertisement, quantity of advertisement, and length of advertisement. By requesting specific advertisements that fulfill these criterions for specific slot placements, a third party client may optimize the impact of or revenue generated from the advertisement slot 510.

It is important to note that while the embodiment shown in FIG. 5 relate to determining advertisement content to include with main media content, other embodiments may involve determining other types of additional content to include with main media content (e.g., subtitles, captions, audio feeds, director's commentaries and so forth). A third party profile may include one or more of the various additional contents that the third party client wishes to include in media feeds sent to its media players.

### Example Method Embodiment

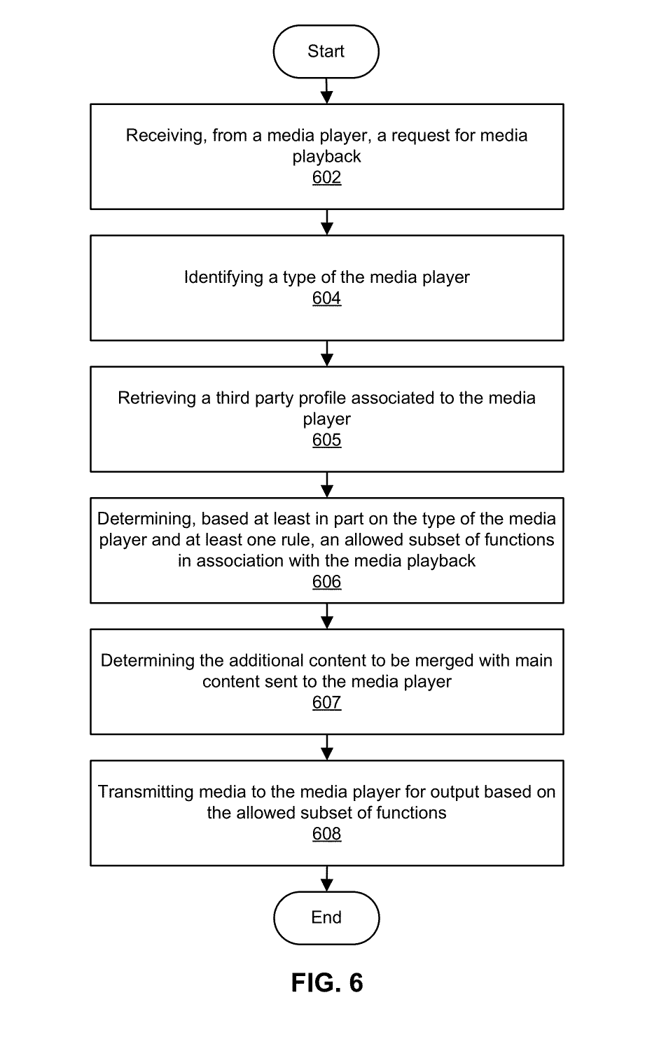

Having disclosed some basic system components and concepts, the disclosure now turns to the exemplary method embodiment shown in FIG. 6. The example method is discussed in terms of an exemplary system 100 as described and shown in FIG. 1, which is configured to practice the method. The steps outlined herein are exemplary and can be implemented in any combination thereof, including combinations that exclude, add, or modify certain steps.

The system 100 receives from a media player a request 602 for media playback. This request can be such that the entire media content is requested at once, such as when an entire video is downloaded, or the request can be such that only a small subsequent portion of media is being requested, such as the subsequent pieces of audio in streaming audio. The system 100 then identifies 604 a type of the media player. In certain instances, this type can be the specific identity of the media player making the request. In other instances, this type is a generic, non-specific type. The type can be identified by an identification sent in the request, by information regarding the skin of the media player, by an internet protocol address, or a computer device code.

In addition to identifying the media player, the system 100 may also identify the third party client that had distributed the media player to users and retrieve a profile associated with the third part client. This profile may have various information about and specifications from the third party client with respect to the media content that will be played on the third party client's media player. Different third party clients may have different profiles associated with them, allowing for received media contents to be personalized for their audiences.

The system 100 then determines 606, based at least in part on the type of the media player and at least one rule, an allowed subset of functions in association with the media playback. In determining the allowed subset of functions, the system 100 limits certain functions, while in some cases allowing otherwise prohibited functionality. Examples of functions which can be limited by the system 100 are the ability to fast forward, rewind, play, pause, change channels, mute, turn on closed captioning, shifting between high and low resolution, recording the media content, screen capturing, or making the request via an application programming interface (API).

In an alternative embodiment, the system 100 can determine 607 content limitations and desired content additions in addition to determining functionality changes. The list of desired additional contents may be specific to each third party client and is recorded in a profile stored by system 100 in a database. Examples of content limitations imposed by the system 100 are the inability to access databases, such as the closed captioning database, media content database, and the advertising database. Content limitations can also include watermarking media content, limiting age restricted content, and administrators can also establish rules dependent upon time, network traffic, and networking capabilities. Desired content additions may include third party client defined sets of content that should be included in media feeds sent to their media players.

The display of the media player can change based on functional limitations or content preferences imposed by rules or specifications. For instance, a media player lacking the ability to rewind may continue to have an inoperative button, or the button can be removed. The system 100 then transmits 608 the modified media feed to the media player for output based on the allowed subset of functions and the inserted desired contents. The media transmitted to the media player complies with the rules and specifications associated with the identified type of media player and its third party client.

### Additional Considerations

Embodiments may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope. For example, the principles herein apply equally to video media as to audio media. Those skilled in the art will readily recognize various modifications and changes that may be made to the principles described herein without following the example embodiments and applications illustrated and described herein, and without departing from the spirit and scope.

We claim:

1. A method comprising:
receiving, from a media player, a request for media playback;
identifying, via a processor, a type of the media player;
determining, based at least in part on the type of the media player and at least one rule, an allowed subset of media functions in association with the media playback;
selecting, based at least in part on a third party client profile, a set of advertisements included with the media playback; and
transmitting media to the media player for output based on the allowed subset of media functions.

2. The method of claim 1, wherein the allowed subset of media functions comprises at least one of fast forwarding, rewinding, playing, pausing, channel changing, muting, and enabling closed captioning.

3. The method of claim 1, wherein an administrator can modify the at least one rule.

4. The method of claim 1, wherein the allowed subset of media functions comprises a modified allowable media content.

5. The method of claim 1, wherein a display associated with the media player is modified according to the allowed subset of media functions.

6. The method of claim 1, wherein the media receives a watermark.

7. The method of claim 1, wherein the allowed subset of media functions are based at least in part on a media type requested.

8. The method of claim 7, wherein the media type requested is at least one of a live program, a pre-recorded program, a high-resolution video, and a low-resolution video.

9. The method of claim 1, wherein the allowed subset of media functions is based at least in part on a connection type.

10. The method of claim 9, wherein the connection type is one of a wired connection, a wireless connection, a Wireless Fidelity (Wi-Fi) connection, a 3-G connection, a wired connection, and a fiber-optic connection.

11. A system comprising:
a processor; and
a non-transitory computer-readable storage medium having stored therein instructions, which when executed on the processor perform a method comprising:
receiving, from a media player, a request for media playback;
identifying a type of the media player;
determining, based at least in part on the type of the media player and at least one rule, an allowed subset of functions in association with the media playback;
selecting, based at least in part on a third party client profile, a set of advertisements included with the media playback; and
transmitting media to the media player for output based on the allowed subset of functions.

12. The system of claim 11, wherein the allowed subset of functions comprises at least one of fast forwarding, rewinding, playing, pausing, channel changing, muting, and enabling closed captioning.

13. The system of claim 11, wherein an administrator can modify the at least one rule.

14. The system of claim 11, wherein the allowed subset of functions comprises a modified allowable media content.

15. The system of claim 11, wherein a display associated with the media player is modified according to the allowed subset of functions.

16. The system of claim 11, wherein the media receives a watermark.

17. A non-transitory computer-readable storage medium having stored therein instructions which, when executed by a computing device, cause the computing device to perform steps comprising:
receiving, from a media player, a request for media playback;
identifying a type of the media player;
determining, based at least in part on the type of the media player and at least one rule, an allowed subset of functions in association with the media playback;
selecting, based at least in part on a third party client profile, a set of advertisements included with the media playback; and
transmitting media to the media player for output based on the allowed subset of functions.

18. The non-transitory computer-readable storage medium of claim 17, wherein the allowed subset of functions are based at least in part on a media type requested.

19. The non-transitory computer-readable storage medium of claim 17, wherein the media type requested is at least one of a live program, a pre-recorded program, a high-resolution video, and a low-resolution video.

20. The non-transitory computer-readable storage medium of claim 17, wherein the allowed subset of functions is based at least in part on a connection type.
